(19) United States
(12) Patent Application Publication
(10) Pub. No.: US 2007/0178030 A1
(43) Pub. Date: Aug. 2, 2007

(54) EXPANDABLE HOUSING GENERATOR

(76) Inventor: Julian T. Ross, McKinney, TX (US)

Correspondence Address: CARR LLP, 670 FOUNDERS SQUARE, 900 JACKSON STREET, DALLAS, TX, 75202, US

(21) Appl. No.: 11/668,376

(22) Filed: Jan. 29, 2007

Related U.S. Application Data
(60) Provisional application No. 60/762,675, filed on Jan. 27, 2006.

(51) Int. Cl. B01J 7/00

(52) U.S. Cl. 422/305

(57) ABSTRACT

An expandable housing generator configured to occupy a small volume in a primed or standby mode, and a larger volume after the commencement of a chemical reaction to generate a gas comprising oxygen. The expandable housing generator may comprise a base housing, a top housing, a first chamber, a second chamber, and a third chamber. The three chambers may separately store components of a catalytic reaction generating the gas. The three chambers may be joined together upon actuation of an activating device. The top housing and at least one of the three chambers may extend along a vertical direction. The extension may accommodate a foam head produced during the reaction. Additionally, the extension may provide a small form factor and consequently better portability and manageability, while also providing sufficient volume to perform the chemical reactions safely and effectively.

### CROSS-REFERENCED APPLICATIONS

This application relates to, and claims the benefit of the filing date of, co-pending U.S. Provisional Patent Application Ser. No. 60/762,675, (Docket No. ROSS 3388000), entitled EXPANDABLE HOUSING GENERATOR, filed Jan. 27, 2006, the entire contents of which are incorporated herein by reference for all purposes.

### BACKGROUND OF THE INVENTION

1. Field of the Invention

The present invention relates to portable oxygen generators and, more particularly, to a portable oxygen generator utilizing a catalytic reaction within an expandable housing.

2. Description of the Related Art

In many applications of portable catalytic oxygen generators, the end use may be for increasing the level of emergency preparedness. These oxygen generators may be stored or carried (e.g., by a consumer, worker, or other professional) in the event that an emergency may occur in which a safe source of oxygen is instantly required. In essence, the oxygen generators are maintained on a standby basis, similar to a typical fire extinguisher. In addition, the oxygen is generated on an on-demand basis at the moment of the emergency (e.g., medical or otherwise). As a result, for most of the life of the device, the oxygen generator is in a “primed mode” or “standby mode.” The period of time during actual operation (i.e., meaning the catalytic generation of oxygen, when the chemicals are mixed and the reaction takes place) may be quite negligible in comparison.

Furthermore, during the chemical reaction that produces the oxygen, there may be foam that develops on the inside of the reaction chamber. This foam may rise during the course of reaction. The so called “foam head” can typically occupy up to 3 times the volume of the base reactants. This foam may be inhibited or reduced by the use of foam breakers, screens, or surfactants. The chemical reactions, the use of foam breakers, the means to deliver the resulting oxygen, and the activation systems, among other information, may be more extensively described in following pending patent applications. These patent applications are all inventions of a sole inventor, Julian Ross, except in certain cases in which Charles Keyes, Jr. is listed as a co-inventor. The entire contents of the patent applications are incorporated herein by reference for all purposes as the “Ross Catalytic Oxygen Patent Applications”:
1. Ser. No. 10/718,131, entitled “Method & Apparatus for Generating Oxygen,” filed Nov. 20, 2003, (Docket No. ROSS 2864000);
2. Ser. No. 10/856,591, entitled “Apparatus and Delivery of Medically Pure Oxygen,” filed May 28, 2004, (Docket No. ROSS 2934000);
3. Ser. No. 11/045,805, entitled “Method and Apparatus for Controlled Production of a Gas,” filed Jan. 28, 2005, (Docket No. ROSS 3050000);
4. Ser. No. 11/158,993, entitled “Method and Apparatus for Controlled Production of a Gas,” filed Jun. 22, 2005, (Docket No. ROSS 3050001);
5. Ser. No. 11/159,016, entitled “Method and Apparatus for Controlled Production of a Gas,” filed Jun. 22, 2005, (Docket No. ROSS 3050002);
6. Ser. No. 11/158,377, entitled “Method and Apparatus for Controlled Production of a Gas,” filed Jun. 22, 2005, (Docket No. ROSS 3050003);
7. Ser. No. 11/158,362, entitled “Method and Apparatus for Controlled Production of a Gas,” filed Jun. 22, 2005, (Docket No. ROSS 3050004);
8. Ser. No. 11/158,618, entitled “Method and Apparatus for Controlled Production of a Gas,” filed Jun. 22, 2005, (Docket No. ROSS 3050005);
9. Ser. No. 11/158,989, entitled “Method and Apparatus for Controlled Production of a Gas,” filed Jun. 22, 2005, (Docket No. ROSS 3050006);
10. Ser. No. 11/158,696, entitled “Method and Apparatus for Controlled Production of a Gas,” filed Jun. 22, 2005, (Docket No. ROSS 3050007)
11. Ser. No. 11/158,648, entitled “Method and Apparatus for Controlled Production of a Gas,” filed Jun. 22, 2005, (Docket No. ROSS 3050008);
12. Ser. No. 11/159,079, entitled “Method and Apparatus for Controlled Production of a Gas,” filed Jun. 22, 2005, (Docket No. ROSS 3050009);
13. Ser. No. 11/158,763, entitled “Method and Apparatus for Controlled Production of a Gas,” filed Jun. 22, 2005, (Docket No. ROSS 3050010);
14. Ser. No. 11/158,865, entitled “Method and Apparatus for Controlled Production of a Gas,” filed Jun. 22, 2005, (Docket No. ROSS 3050011);
15. Ser. No. 11/158,958, entitled “Method and Apparatus for Controlled Production of a Gas,” filed Jun. 22, 2005, (Docket No. ROSS 3050012);
16. Ser. No. 11/158,867, entitled “Method and Apparatus for Controlled Production of a Gas,” filed Jun. 22, 2005, (Docket No. ROSS 3050013);
17. Ser. No. 11/438,651, entitled “Method and Apparatus for Generating Oxygen,” filed May 22, 2006, (Docket No. ROSS 2864003);
18. Ser. No. 11/558,374, entitled “Method and Apparatus For Delivering Therapeutic Oxygen Treatments,” filed Nov. 9, 2006, (Docket No. ROSS 3353001);
19. Ser. No. 11/560,304, entitled “Method and Apparatus for Delivering Oxygenated Heated Vapor in Skin Care Applications,” filed Nov. 15, 2006, (Docket No. ROSS 3361002);
20. Ser. No. 11/567,196, entitled “Method and Apparatus for Controlled Production of a Gas,” filed Dec. 5, 2006, (Docket No. ROSS 3367001);
21. Ser. No. 60/699,094, entitled “Method and Apparatus for Generating Oxygen,” filed Jul. 14, 2005, (Docket No. ROSS 2864002);
22. Ser. No. 60/735,011, entitled “Oxygen Patch,” filed Nov. 15, 2005, (Docket No. ROSS 3353000);
23. Ser. No. 60/736,786, entitled “Method and Apparatus for Delivering Oxygenated Heated Vapor in Skin Care Applications,” filed Nov. 15, 2005, (Docket No. ROSS 3361000);
24. Ser. No. 60/742,436, entitled “Flexible Reaction Chamber with Frangible Seals and Activation Methods,” filed Dec. 5, 2005, (Docket No. ROSS 3367000);
25. Ser. No. 60/763,121, entitled “Method and Apparatus for Delivering Oxygenated Heated Vapor in Skin Care Applications,” filed Jan. 27, 2006, (Docket No. ROSS 3361001);
26. Ser. No. 11/614,244, entitled “METHOD AND APPARATUS FOR PROVIDING IMPROVED AVAILABILITY OF BREATHABLE AIR IN A CLOSED CIRCUIT,” filed Dec. 21, 2006, (Docket No. ROSS 3380003);
27. Ser. No. 11/623,721, entitled “METHOD AND SYSTEM FOR PORTABLE BREATHING DEVICES,” filed Jan. 16, 2007, (Docket No. ROSS 3380008); and
28. Ser. No. 11/623,727, entitled “METHOD AND APPARATUS FOR PORTABLE SELF CONTAINED RE-BREATHING DEVICES,” filed Jan. 16, 2007, (Docket No. ROSS 3380009).

The use of foam breakers, screens, or surfactants, as described in the Ross Catalytic Oxygen Patent Applications may be effective solutions for inhibiting the growth of the foam generated during the gas producing reactions. However, in certain instances the increase in positive pressure resulting from the reaction may reduce the effectiveness of the particular solution used for foam breaking. Therefore, allowing a sufficient “head space” for the foam to develop may become a highly desirable alternative. This may be especially true in high flow applications where the pressure may build up to significant levels inside of the reaction chamber (i.e., potentially presenting a safety hazard). The creation of an area of “head space” may be a complete solution or a partial solution. In other words, the portable generator may be designed with head space in addition to a foam breaker solution that may involve a barrier foam breaker such as a screen, mesh, or a surfactant. Alternatively, the head space could obviate the need for any additional foam breaker solution.

However, designing an area for additional head space into the volume of the reaction chamber(s) may equate to a larger overall form factor for the generator, which may be undesirable. It would be beneficial to provide the additional volume when it is required (e.g., during the chemical reaction), but to otherwise maintain the smallest possible form factor for the majority of the life of the device (e.g., such as during storage and transportation).

### SUMMARY OF THE INVENTION

An expandable generator for catalytically producing a gas that comprises oxygen. The expandable generator may comprise a housing base and a housing top translatably coupled to the housing base. The housing base may contain a first chamber, a second chamber, and a third chamber. The first chamber, the second chamber, and the third chamber may be separated from one another by frangible seals. The first chamber, the second chamber, and the third chamber may respectively store a first component, a second component, and a third component of a chemical reaction to produce the gas. The expandable generator may further comprise one or more activation tabs configured to breach the one or more frangible seals when actuated, thereby commencing the chemical reaction. The housing top and at least one of a group consisting of the first chamber, the second chamber, and the third chamber, may be configured to extend along a vertical direction.

### BRIEF DESCRIPTION OF THE DRAWINGS

For a more complete understanding of the present invention and the advantages thereof, reference is now made to the following Detailed Description taken in conjunction with the accompanying drawings, in which:

FIG. 1A shows an embodiment of an oxygen generator according to the present invention in a “standby mode”;

FIG. 1B shows the generator of FIG. 1A partially deployed;

FIG. 1C shows the generator of FIG. 1A fully deployed;

FIG. 2A shows an embodiment of an inner cartridge prior to activation;

FIG. 2B shows the inner cartridge of FIG. 2A subsequent to activation and fully expanded;

FIG. 3A shows cross-sectional side view of an embodiment of an outer housing and a single inner cartridge assembly in a stand by mode;

FIG. 3B shows cross-sectional side view of an embodiment of an outer housing and double inner cartridge assembly in a stand by mode;

FIG. 4A shows a cross-sectional side view of another embodiment of an outer housing and double inner cartridge assembly in a stand by mode; and

FIG. 4B shows a cross-sectional side view of the outer housing and double inner cartridge assembly of FIG. 4A subsequent to activation and fully expanded.

### DETAILED DESCRIPTION

In the following discussion, numerous specific details are set forth to provide a thorough understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, for the most part, details concerning well known features and elements have been omitted inasmuch as such details are not considered necessary to obtain a complete understanding of the present invention, and are considered to be within the understanding of persons of ordinary skill in the relevant art.

The entire contents of Provisional Patent Application Ser. No. 60/762,675, (Docket No. ROSS 3388000), entitled “EXPANDABLE HOUSING GENERATOR”, filed Jan. 27, 2006, is incorporated herein by reference for all purposes.

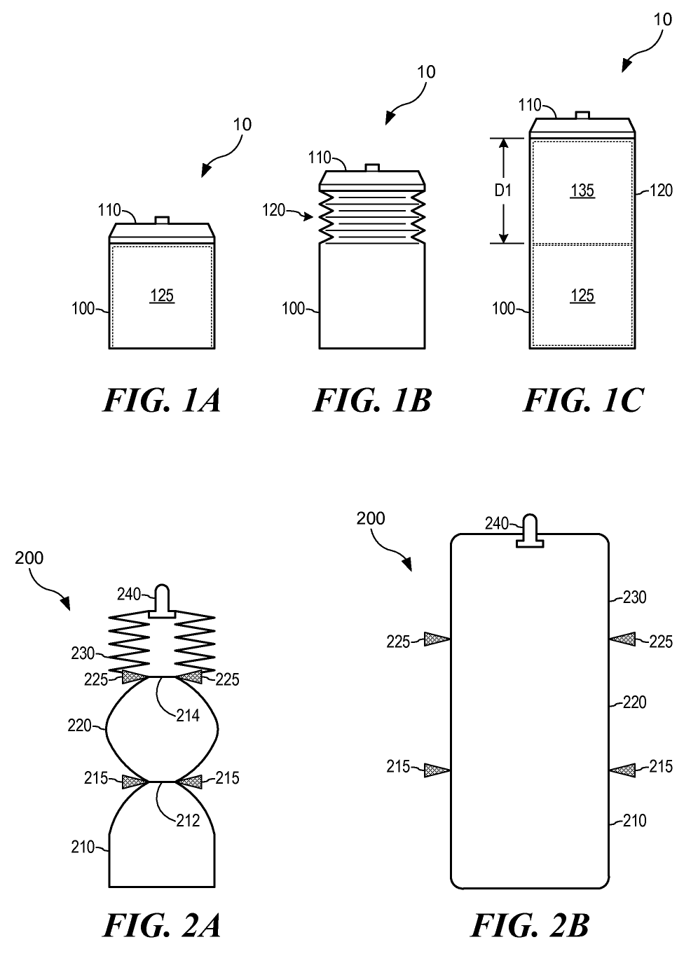

Turning now to the drawings, FIG. 1A shows an illustrative embodiment of the present invention. In this drawing, reference number 10 generally indicates an expandable oxygen generating device 10. The expandable generator 10 may comprise an outer housing base 100, an outer housing top 110, and a primed volume 125. The expandable generator 10 may be seen in FIG. 1A in a primed mode, in which the outer housing top 110 abuts a top edge of the outer housing base 100. The primed volume 125 may be sufficient to accommodate the chemical reactants, actuation mechanisms (if any), and filtration apparatus (if any). The outer housing top 110 may be releasably coupled to the outer housing 100 through the use of tabs, clasps, belts, overlapping interconnecting structures, among others. The outer housing top 110 may be vertically movable with respect to the outer housing base 100. In this illustrative embodiment, the outer housing top 110 and the outer housing base 100 may be made of a rigid plastic or thermoplastic, such as for example polycarbonate or acrylonitrile butadiene styrene (ABS), among others.

Turning now to FIG. 1B, the expandable generator 10 is shown at a point in time after the commencement of the oxygen producing catalytic chemical reaction. The outer housing top 110 may be translatably coupled with the outer housing base 100 via a flexible member 120. The outer housing top 110 may be effectively extended or raised relative to the outer housing base 100. The outer housing base 100 may remain relatively static or stationary. FIG. 1B shows the expandable generator 10 partially deployed. The flexible member 120 may be configured in the form of an accordion, so as to extend and fold as the unit is activated or placed into storage.

Turning now to FIG. 1C, the expandable generator 10 may be fully deployed. The outer housing top 110 may be at a maximum height relative to the outer housing base 100. The flexible member 120 may be fully expanded. In addition to the primed volume 125, the expandable generator 10 may now comprise a top head volume 135. Any foam generation that may occur as the result of the oxygen generating reaction may move into the top head volume 135.

Turning now to FIG. 2A, the expandable generator 10 (FIG. 1A) may comprise an inner cartridge 200. The inner cartridge 200 may contain the reaction and provide an activation mechanism. The inner cartridge 200 may comprise a first chamber 210, a second chamber 220, and a third chamber 230. The inner cartridge 200 may also comprise a frangible seal 212, a frangible seal 214, activation tags 215, and activation tags 225. In addition, the inner cartridge 200 may comprise an outlet port 240. The outlet port 240 may provide an exit for the generated oxygen or gas, as the case may be, to exit the inner cartridge 200 and be transported to a user via a delivery tube, for example.

The first chamber 210 may be separated from the second chamber 220 by the frangible seal 212. The second chamber 220 may be separated from the third chamber 230 by the frangible seal 214. Each of the three chambers 210, 220, 230, may separately contain a component required for the oxygen producing chemical reaction. By manipulating the activation tags 215, 225 (e.g., by pulling away from each other), the frangible seals 212, 214 may be breached, allowing the chemical reactants to combine and commence the chemical reaction. However, other methods may be used to breach the frangible seals 212, 214, such as applying pressure to one or more of the chambers 210, 220, 230, for example. In certain embodiments, the inner cartridge 200 may be made of a flexible material including, but not limited to plastic, rubber, neoprene, among others, and may be configured to expand upon commencement of the reaction.

Turning now to FIG. 2B, this drawing shows the inner cartridge 200 in a fully expanded state, after the commencement of the reaction. As seen in this figure, all three chambers 210, 220, 230 may have expanded beyond their storage or primed configuration. However, embodiments of the present invention may not be limited to this example. In certain embodiments, the three chambers 210, 220, 230 may only have one expanding chamber, or two or more expanding chambers. As shown in FIG. 2A, the third chamber 230 may be formed with a series of folds to allow for an increased level of expansion after commencement of the reaction. The outlet port 240 may be configured to be attached to the top of the inner cartridge 200. In such a case, the outlet port 240 may rise as the inner cartridge 200 expands. Prior to the outlet port 240 may be a foam breaker and/or a foam filter (not shown). The foam breaker may comprise open celled foams, coarsely woven materials, or expanded extrusions, among others. The material for the foam breaker may comprise polypropylene, polyethylene, among other materials inert to the catalytic oxygen generating reaction specifics and not configured to absorb water (i.e., hydrophobic). Various types of materials used in the foam breaker may create an open cell structure that may facilitate the flow through of gas but effectively break down the bubbles of the foam, potentially suppressing the growth of a foam head within the inner cartridge 200. The foam breaker may also act as a pre-filter, breaking down bubbles, speeding the release of oxygen, and facilitating the return of water to the catalytic reaction. Additionally, the foam breaker may create a tortuous path for the generated oxygen gas, allowing the condensing of water and a cooling of the oxygen gas. More details and alternative embodiments for cartridges and activation of cartridges may be found in the Ross Catalytic Oxygen Patent Applications, the entire contents of which are incorporated herein by reference for all purposes.

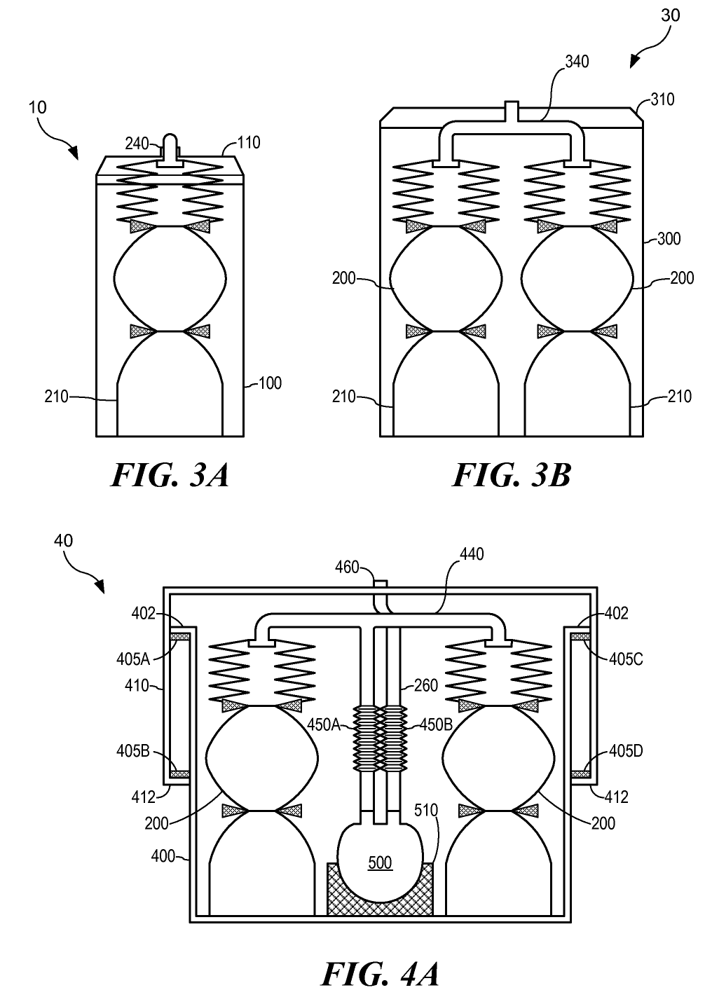

Turning now to FIG. 3A, the expandable generator 10 may comprise the inner cartridge 200. As shown in this figure, the expandable generator 10 may be in a primed or standby mode, prior to commencing of the chemical reaction. The outer housing top 110 may be adjacent to the outer housing base 100. In addition, the outlet port 240 may extend through the outer housing top 110. As shown in the previous figures, as the inner chamber 200 expands, the outer housing top 110 may extend along with the outlet port 240. The outer housing base 100 may be adhered or attached to the first chamber 200 to prevent the inner cartridge 200 from moving within the outer housing base 100 or becoming separated from the outer housing base 100. The inner cartridge 200 may be attached to the outer housing base 100 through the use of brackets (not shown) situated proximate to an interior surface of the outer housing base 100. Otherwise, the inner cartridge 200 may lift up as the outer housing top 110 is moved in an upward direction relative to the outer housing base 100 after activation.

Turning now to FIG. 3B, another illustrative embodiment of the present invention may comprise an expandable generator 30 containing two or more inner cartridges 200 (e.g., two are shown in the figure) in a larger outer housing base 300 and outer housing top 310. The first chamber 210 of each of the inner cartridges 200 may be attached to outer housing base 300 to prevent their moving up relative to the outer housing base 300 after activation. The inner cartridges 200 may be directly attached to the outer housing base 300 via chemical adhesives, fasteners, among others, or indirectly attached to the outer housing base 300 via intermediary members such as brackets situated at an interior surface of the outer housing base 300, for example. The inner cartridges 200 may be removably attached to the outer housing base 300 so as to facilitate repair or reuse of the outer housing base 300 and the outer housing top 310 after a single emergency use. The outer housing top 310 may be movably coupled with the outer housing base 300 via a flexible membrane (not shown in this view).

The two inner cartridges 200 may be fluidly coupled with an outlet manifold 340. The outlet manifold 340 may be directly attached to each of the inner cartridges 200. Alternatively, the outlet manifold 340 may be attached to each of the outlet ports 240 (FIG. 2A). The outlet manifold 340 may be coupled with the outer housing top 310 and configured to rise along with the outer housing top 310 after activation of the chemical reaction. Although only two inner cartridges 200 may be shown, the outlet manifold 340 may be configured to couple three or more inner cartridges 200 together within an appropriately sized outer housing.

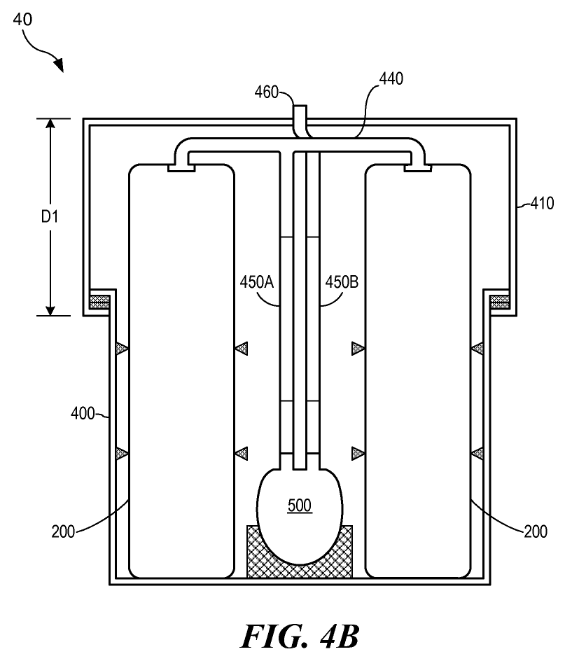

Turning now to FIG. 4A, another embodiment of the present invention may comprise an expandable generator 40. The expandable generator 40 may comprise an outer housing base 400 and an outer housing top 410. Within the outer housing base 400, and the outer housing top 410, the expandable generator 40 may comprise two or more inner cartridges 200, an outlet manifold 440, expandable connections 450A, 450B, an outlet riser 460, and a water trap 500. The water trap 500 and/or the inner cartridges 200 may be secured to the outer housing base 400 via a bracket 510.

The outer housing base 400 may further comprise a base lip 402 extending outward from the top edge of the outer housing base 400. The outer housing top 410 may further comprise a top lip 412 extending toward the interior of the outer housing top 410 from a lower edge of the outer housing top 410. The base lip 402 and the top lip 412 may substantially overlap one another in a vertical direction when the outer housing top 410 is assembled to the outer housing base 400. Additionally, an outer edge of the base lip 402 may slidingly abut an interior surface of the outer housing top 410. An interior edge of the top lip 412 may slidingly abut an exterior surface of the outer housing base 400. The outer housing top 410 may slidingly translate in a vertical direction relative to the outer housing base 400 after activation of the chemical reaction. Seals 405A, 405B, 405C, and 405D, may allow the outer housing top 410 to sealingly slide relative to the outer housing base 400 after activation. The slidable coupling between the outer housing top 410 and the outer housing base 400 may eliminate the need for a flexible member attached to both components (e.g., as with flexible member 120 in expandable generator 10 shown in FIGS. 1B and 1C). As shown in FIG. 4A, the outer housing top 410 and the outer housing base 400 may be in a primed or standby mode.

Two or more inner cartridges 200 may be contained within the outer housing base 400 and the outer housing top 410. The inner cartridges 200 may be fluidly coupled to one another via the outlet manifold 440. The outlet manifold 440 may be fluidly coupled via the expandable connection 450A to an inlet of the water trap 500. An outlet of the water trap 500 may be fluidly coupled via the expandable connection 450B to the outlet riser 460. The outlet riser 460 may be coupled to the outer housing top 410, so as to rise along with the rising of the outer housing top 410 after commencement of the chemical reaction.

The water trap 500 and/or the inner cartridges 200 may be secured to an interior surface of the outer housing base 400 through a bracket 510. Alternatively, the water trap 500 and/or the inner cartridges 200 may be secured to an interior surface of the outer housing base 400 through the use of fasteners, welding (ultrasonic or otherwise), adhesive, straps, or interconnecting surfaces, among others. The securing of the water trap 500 and/or the inner cartridges 200 may inhibit or prevent the unintended movement of these components during shipping and storage and inhibit or prevent the rising up of these components along with the rising of the outer housing top 410 relative to the outer housing base 400 after activation of the chemical reaction.

Turning now to FIG. 4B, the expandable generator 40 is shown in a fully expanded state after activation of the oxygen producing chemical reaction. The outer housing top 410 may have translated relative to the outer housing base 400 such that an additional head distance of D1 may be present. Within the outer housing base 400 and the outer housing top 410, the inner cartridges 200 may also be at a fully expanded state. As the inner cartridges 200 expand, they may move the outlet manifold 440 with respect to water trap 500. The expandable connection 450A may expand to accommodate this difference in distance. The expandable connection 450A may be in the form of a convoluted tube folded upon itself. Alternatively, the expandable connections 450 may comprise a resilient material able to stretch an appropriate distance without folds, or the expandable connection 450 may comprise an extra length of resilient tubing stored within the outer housing base 400. The outlet riser 460 may comprise some extra tubing to allow the outer housing top 410 to be opened without disconnecting the outlet riser 460.

The expandable generator 40 may be used as follows. The expandable generator 40 may be retrieved from storage in a primed or standby mode may be retrieved from storage. The activation tabs 215, 225 (FIG. 2A) may be pulled or actuated. The frangible seals 212, 214 (FIG. 2A) may be breached, allowing the previously separated reactants in each of the three chambers 210, 220, and 230, to flow together, commencing an oxygen producing catalytic reaction. The inner cartridges 200 may start to expand, slidably moving the outer housing top 410 away from the outer housing base 400. As the inner cartridges 200 expand, the outlet manifold 440 moves away from the water trap 500. A flexible connection 450A may provide for the maintaining of the fluid connection between the outlets of the inner cartridges 200 and the inlet of the water trap 500. As gas flows through the tubing, the gas may be bubbled through water contained within the water trap 500. Bubbled gas may then exit from the water trap 500.

The bubbled gas may flow from the exit of the water trap 500 into an expandable connection 450B. The expandable connection 450B may allow the outlet riser 460 to remain coupled to the outer housing top 410 through the expansion. From the outlet riser 460, the generated oxygen gas may be administrated to a user or victim of an emergency situation.

### ALTERNATIVE EMBODIMENTS

The outer housing top may rise relative to the outer housing base due to a pressure build up within an activated inner cylinder. However, the outer housing top may be manually pulled away from the outer housing base. Additionally, or alternatively, a separate mechanism may exists for moving the outer housing top away from the outer housing base, such as a lever, linkage, pneumatic strut, among others. Also, the outer housing top may be held in place away from the outer housing base due to a support mechanism.

Having thus described embodiments of the present invention by reference to certain exemplary embodiments, it is noted that the embodiments disclosed are illustrative rather than limiting in nature. A wide range of variations, modifications, changes, and substitutions are contemplated in the foregoing disclosure. In some instances, some features of an embodiment of the present invention may be employed without a corresponding use of the other features. Many such variations and modifications may be considered desirable by those skilled in the art based upon a review of the foregoing description of the illustrative embodiments. Accordingly, it is appropriate that the appended claims be construed broadly and in a manner consistent with the scope of the invention.

We claim:

1. An expandable generator for catalytically producing a gas that comprises oxygen, the expandable generator comprises:
a housing base;
a housing top translatably coupled to the housing base;
a first chamber, a second chamber, and a third chamber within the housing base and wherein the first chamber, the second chamber, and the third chamber are separated from one another by frangible seals;
a first component, a second component, and a third component of a chemical reaction to produce the gas, and respectively stored in the first chamber, the second chamber, and the third chamber;
one or more activation tabs configured to breach one or more frangible seals when actuated, thereby commencing the chemical reaction; and
wherein the housing top and at least one of a group consisting of the first chamber, the second chamber, and the third chamber, are configured to extend along a vertical direction.

2. The expandable generator as detailed in claim 1, wherein the housing top is translatably coupled to the housing base via a flexible membrane.

3. The expandable generator as detailed in claim 2, wherein the expandable generator further comprises:
a first cartridge that comprises the first chamber, the second chamber, and the third chamber;
a second cartridge that comprises a first chamber, a second chamber, and a third chamber; and
an outlet manifold fluidly coupling with the first cartridge and the second cartridge, and coupling with the housing top.

4. The expandable generator as detailed in claim 1, wherein the housing top is translatably coupled to the housing base via a sliding interface.

5. The expandable generator as detailed in claim 4, wherein the expandable generator further comprises:
a first cartridge that comprises the first chamber, the second chamber, and the third chamber;
a second cartridge that comprises a first chamber, a second chamber, and a third chamber; and
an outlet manifold fluidly coupling with the first cartridge and the second cartridge, and coupling with the housing top.

6. An expandable generator for catalytically producing a gas that comprises oxygen, the expandable generator comprises:
a housing base;
a housing top translatably coupled to the housing base;
at least one chamber comprising a component of a chemical reaction to produce the gas, wherein a number of chambers is not greater than a number of components of the chemical reaction;
at least one second chamber comprising a component of a chemical reaction to produce the gas, wherein a number of second chambers is not greater than the number of components of the chemical reaction;
an outlet manifold fluidly coupling with the at least one chamber and the at least one second chamber;
a water trap fluidly coupled with the at least one chamber and the at least one second chamber;
an actuator configured to commence a chemical reaction in the at least one chamber and the at least one second chamber; and
wherein the housing top and at least one chamber and at least one second chamber are configured to extend along a vertical direction.

7. The expandable generator as detailed in claim 6, wherein the housing top is translatably coupled to the housing base via a flexible membrane.

8. The expandable generator as detailed in claim 7, wherein a first cartridge comprises the at least one chambers; and
a second cartridge comprises the at least one second chambers.

9. The expandable generator as detailed in claim 6, wherein the housing top is translatably coupled to the housing base via a sliding interface.

10. The expandable generator as detailed in claim 9, wherein a first cartridge comprises the at least one chambers; and
a second cartridge comprises the at least one second chambers.

11. A method for using an expandable generator that comprises:
retrieving the expandable generator from storage;
actuating an activating device within the expandable generator, commencing the catalytic generation of a gas comprising oxygen;
extending a housing top vertically relative to a housing base; and
providing the generated oxygen to a person.

12. The method for using an expandable generator of claim 11 wherein the housing top is movably coupled to the housing base via a flexible member.

13. The method for using an expandable generator of claim 11 wherein the housing top is movably coupled to the housing base via a sliding interface.

14. A cartridge for an expandable generator that comprises:
a first chamber comprising an outlet port and a first component of a chemical reaction that catalytically generates a gas comprising oxygen;
a second chamber comprising a second component of the chemical reaction and coupled to the first chamber via a first frangible seal;
a third chamber comprising a third component of the chemical reaction and coupled to the second chamber via a second frangible seal;
a first activation tab coupled to the first frangible seal such that actuating the first activation tab breaches the first frangible seal;
a second activation tab coupled to the second frangible seal such that actuating the second activation tab breaches the second frangible seal; and
wherein at least one of the group consisting of the first chamber, the second chamber, and the third chamber, is configured to extend along a vertical direction.
